(19) United States
(12) Patent Application Publication
(10) Pub. No.: US 2026/0042927 A1
(43) Pub. Date: Feb. 12, 2026

(54) CONDUCTIVE INK COMPOSITION AND CONDUCTIVE FILM

(71) Applicant: Lion Specialty Chemicals Co., Ltd., Tokyo (JP)

(72) Inventors: Hiromu SATO, Tokyo (JP); Kasumi MUKAIDA, Tokyo (JP)

(73) Assignee: Lion Specialty Chemicals Co., Ltd., Tokyo (JP)

(21) Appl. No.: 19/291,508

(22) Filed: Aug. 5, 2025

(30) Foreign Application Priority Data
Aug. 8, 2024 (JP) 2024-133320

(51) Int. Cl. C09D 11/52; C09D 11/037; C09D 11/107; H01B 1/22

(52) U.S. Cl. CPC C09D 11/52; C09D 11/037; C09D 11/107; H01B 1/22

(57) ABSTRACT

A conductive ink composition including a (meth)acrylic polymer (A) and silver particles (B), wherein the (meth)acrylic polymer (A) contains a first (meth)acrylic polymer (A-1) and a second (meth)acrylic polymer (A-2), the first (meth)acrylic polymer (A-1) has a glass transition temperature of 0° C. or lower and a weight average molecular weight of 500,000 or more, the second (meth)acrylic polymer (A-2) has a glass transition temperature of 0° C. or lower and a weight average molecular weight of less than 500,000, and surfaces of the silver particles (B) are coated with a fatty acid containing oleic acid.

### BACKGROUND OF THE INVENTION

### Field of the Invention

The present invention relates to a conductive ink composition and a conductive film using the conductive ink composition.

Priority is claimed on Japanese Patent Application No. 2024-133320, filed Aug. 8, 2024, the content of which is incorporated herein by reference.

### Description of Related Art

In recent years, printed electronics (PE) in which an electronic circuit is formed by a printing method such as screen printing using a conductive ink has been attracting attention in the field of electronic device production. By using PE, for example, it is possible to produce a flexible device by forming an electronic circuit on a thin substrate.

Patent Document 1 proposes a conductive ink for screen printing.

Screen printing is a type of stencil printing, and is a printing method in which ink is layered on a screen plate and pressed with a squeegee or the like so that the ink passes through an open mesh of the screen plate.

### PRIOR ART DOCUMENTS

### Patent Document

[Patent Document 1] Japanese Unexamined Patent Application, First Publication No. 2011-246498

### SUMMARY OF THE INVENTION

### Problems to be Solved by the Invention

An ink composition used when printing a fine wiring pattern by a screen printing method or the like is required to have fine line printability that allows fine lines called lines and spaces (L/S) to be formed as designed, and surface smoothness that makes it easy for the coating film surface to be smooth after printing. If the surface smoothness is favorable, a mesh mark of the screen plate is less likely to be generated on the printed coating film.

In addition, in recent years, stretchability so as to follow a stretchable substrate and excellent conductivity after stretching are required.

The present invention has an object of providing a conductive ink composition exhibiting favorable fine line printability and surface smoothness after printing, and capable of forming a conductive film that is stretchable and exhibits excellent electrical conductivity after stretching.

### Means for Solving the Problem

The present invention includes the following aspects.

[1] A conductive ink composition including a (meth)acrylic polymer (A) and silver particles (B), wherein the aforementioned (meth)acrylic polymer (A) contains a first (meth)acrylic polymer (A-1) and a second (meth)acrylic polymer (A-2), the aforementioned first (meth)acrylic polymer (A-1) has a glass transition temperature of 0° C. or lower and a weight average molecular weight of 500,000 or more, the aforementioned second (meth)acrylic polymer (A-2) has a glass transition temperature of 0° C. or lower and a weight average molecular weight of less than 500,000, and surfaces of the aforementioned silver particles (B) are coated with a fatty acid containing oleic acid.

[2] The conductive ink composition according to [1], wherein the aforementioned first (meth)acrylic polymer (A-1) has a glass transition temperature of more than −60° C. and less than −30° C., a weight average molecular weight of 500,000 or more and 990,000 or less, and a hydroxyl value of 50 mgKOH/g or more.

[3] The conductive ink composition according to [1], wherein the aforementioned first (meth)acrylic polymer (A-1) has a glass transition temperature of more than −60° C. and less than −40° C., a weight average molecular weight of 750,000 or more and 990,000 or less, and a hydroxyl value of 50 mgKOH/g or more.

[4] The conductive ink composition according to any one of [1] to [3], wherein the aforementioned second (meth)acrylic polymer (A-2) has a glass transition temperature of more than −65° C. and less than 0° C., and a weight average molecular weight of 150,000 or more and less than 500,000.

[5] The conductive ink composition according to any one of [1] to [4], wherein a content of the aforementioned oleic acid with respect to a total mass of the aforementioned fatty acid is 85% by mass or more.

[6] The conductive ink composition according to any one of [1] to [5], wherein a loss factor tan δ measured by changing an amount of strain from 0.001% to 100% at a temperature of 25° C. and a frequency of 1 Hz is 4.0 or less.

[7] A conductive film obtained by drying a coating film of the conductive ink composition according to any one of [1] to [6].

[8] The conductive film according to [7], which is used for an electrode or wiring that requires stretchability in an electronic device.

[9] The conductive film according to [7], which is used for a detection part, electrode, or wiring of a variable resistance sensor.

[10] A method for producing a conductive film including:
applying the conductive ink composition according to any one of [1] to [6] onto an object to be applied to form a coating film, and
drying the coating film to remove a volatile component.

[11] The method for producing a conductive film according to [10], wherein the object to be applied is a stretchable substrate made of a stretchable material selected from the group consisting of polyurethane, ethylene propylene rubber, silicone rubber, and various elastomers.

[12] The method for producing a conductive film according to or [11], wherein applying the conductive ink composition is performed by a method selected from the group consisting of a printing method, a dipping method, a spray method, and a bar coating method.

[13] The method for producing a conductive film according to [12], wherein the printing method is selected from the group consisting of an inkjet printing method, a flexographic printing method, a gravure printing method, a screen printing method, a pad printing method, and a lithography printing method.

[14] An electrode or wiring that requires stretchability in an electronic device, which is formed or configured by the conductive film according to [7].

[15] A detection part, electrode, or wiring of a variable resistance sensor, which is formed or configured by the conductive film according to [7].

### Effects of the Invention

According to the present disclosure, it is possible to obtain a conductive ink composition exhibiting favorable fine line printability and surface smoothness after printing, and capable of forming a conductive film that is stretchable and exhibits excellent electrical conductivity after stretching.

### DETAILED DESCRIPTION OF THE INVENTION

The following definitions of terms apply throughout the present specification and claims.

A numerical range represented by a symbol “-” means a numerical range having numerical values before and after this symbol “-” as the lower limit and upper limit values.

A (meth)acrylic polymer is a polymer containing a unit based on a (meth)acrylate. The content of the unit based on a (meth)acrylate is preferably 70% by mass or more, more preferably 80% by mass or more, still more preferably 90% by mass or more, and may be 100% by mass with respect to all units constituting the (meth)acrylic polymer.

The term “(meth)acrylate” is a generic term for acrylate and methacrylate, and the term “(meth)acrylic” is a generic term for “acrylic” and “methacrylic.”

A “unit” of a polymer means an atomic group (monomer unit) formed from one monomer molecule.

The weight average molecular weight (Mw) of a polymer is a polystyrene equivalent molecular weight obtained through measurement by gel permeation chromatography using a calibration curve produced using a standard polystyrene sample with a known molecular weight. More specifically, it can be determined, for example, by using “Alliance E2695 Separation Module” (product name) manufactured by Nihon Waters K. K. as a GPC measuring device, and measuring a polystyrene equivalent value under the following GPC measurement conditions.

### <GPC Measurement Conditions>

Sample concentration: 0.5% by weight (tetrahydrofuran solution)
Sample injection volume: 20 μL
Eluent: tetrahydrofuran (THF)
Flow rate (flow velocity): 0.3 mL/min
Column temperature (measurement temperature): 40° C.
Column: “TSKguard column HSPgel RT-MB-H+HSPgel RT-2.0” (product name, manufactured by Tosoh Corporation)
Detector: differential refractometer (RI), “Alliance 2414” (product name, manufactured by Nihon Waters K. K.)

A hydroxyl value (unit: mgKOH/g) of a polymer is a value calculated from a theoretical value. It is calculated from the following formula (1). In the following formula (1), the expression “copolymerized amount of a monomer having a hydroxyl group” means a ratio (unit: % by mass) of the monomer having a hydroxyl group with respect to all monomers constituting a polymer.

$$Hydroxyl value = \frac{\begin{matrix}copolymerized amount of \\ monomer having hydroxyl group\end{matrix}}{\begin{matrix}molecular weight of \\ monomer having hydroxyl group\end{matrix}} \times \frac{molecular weight of KOH}{100} \times 1000 \qquad [ Equation 1 ]$$

A glass transition temperature of a copolymer obtained by polymerizing a monomer mixture is Tg (theoretical value) calculated from the Fox equation in the following formula (2) using a known glass transition temperature of a homopolymer of each monomer. For the glass transition temperature of homopolymer of a monomer, for example, the value described in Polymer Handbook Fourth edition (Wiley-Interscience, 2003) can be used.

In the following formula (2),
Tg represents a glass transition temperature of a copolymer (unit: K),
Tg₁ represents a glass transition temperature of a homopolymer of a monomer 1 (unit: K),
Tg₂ represents a glass transition temperature of a homopolymer of a monomer 2 (unit: K),
Tgₙ represents a glass transition temperature of a homopolymer of a monomer n (unit: K),
W₁ represents a weight fraction of the monomer 1 in a monomer mixture,
W₂ represents a weight fraction of the monomer 2 in the monomer mixture, and
Wₙ represents a weight fraction of the monomer n in the monomer mixture.

$$\frac{1}{Tg} = \frac{{W}_{1}}{{Tg}_{1}} + \frac{{W}_{2}}{{Tg}_{2}} + … + \frac{{W}_{n}}{{Tg}_{n}} \qquad [ Equation 2 ]$$

The 50% average particle size of silver particles is a median diameter at 50% cumulative volume in a particle size distribution curve measured by a laser diffraction particle sizer.

The fatty acid content (fatty acid coating amount) with respect to the total mass of silver particles can be measured by TG-DTA and from the mass of the residue after sintering the silver particles at 800° C. for 30 minutes.

The composition of the fatty acid that coats the surface of the silver particles can be measured by gas chromatography (GC).

### <<Conductive Ink Composition>>

A conductive ink composition of the present embodiment contains a (meth)acrylic polymer (A) and silver particles (B).

### < (Meth)Acrylic Polymer (A)>

The (meth)acrylic polymer (A) is composed of two or more types of (meth)acrylic polymers.

The (meth)acrylic polymer (A) contains a first (meth)acrylic polymer (A-1) (hereinafter also referred to as a “polymer (A-1)”) and a second (meth)acrylic polymer (A-2) (hereinafter also referred to as a “polymer (A-2)”).

The polymer (A-1) and the polymer (A-2) are both polymers with a glass transition temperature of 0° C. or lower. The weight average molecular weight of the polymer (A-1) is 500,000 or more, and the weight average molecular weight of the polymer (A-2) is less than 500,000.

The polymer (A-1) and the polymer (A-2) are both polymers containing a unit based on a (meth)acrylate. In each of the polymer (A-1) and the polymer (A-2), the content of the unit based on a (meth)acrylate is preferably 70% by mass or more, more preferably 80% by mass or more, still more preferably 90% by mass or more, and may be 100% by mass with respect to all units constituting the polymer.

In each of the polymer (A-1) and the polymer (A-2), examples of the unit based on a (meth)acrylate constituting the polymer include the following units (a1) to (a5).

[Unit (a1)]

The unit (a1) is a unit (a1) based on a hydroxyl group-containing monomer. The unit (a1) increases the hydroxyl value of the polymer.

The unit (a1) is preferably a unit based on a (meth)acrylate having a hydroxyl group.

Specific examples of a hydroxyl group-containing monomer (a1) corresponding to the unit (a1) include 2-hydroxyethyl acrylate, 2-hydroxypropyl acrylate, 4-hydroxybutyl acrylate, and 2-hydroxyethyl methacrylate.

[Unit (a2)]

The unit (a2) is a unit based on a (meth)acrylate having an alkyl group of 4 to 12 carbon atoms. The unit (a2) does not include the unit (a1).

The alkyl group having 4 to 12 carbon atoms in the unit (a2) may be linear or branched.

Specific examples of a (meth)acrylate (a2) corresponding to the unit (a2) include n-butyl (meth)acrylate, isobutyl (meth)acrylate, s-butyl (meth)acrylate, t-butyl (meth)acrylate and 2-ethylhexyl (meth)acrylate.

[Unit (a3)]

The unit (a3) is a unit based on a (meth)acrylate having an alkyl group of 1 to 3 carbon atoms. The unit (a3) does not include the unit (a1) and the unit (a2). The alkyl group having 3 carbon atoms in the unit (a3) may be linear or branched.

Specific examples of a (meth)acrylate (a3) corresponding to the unit (a3) include methyl (meth)acrylate and ethyl (meth)acrylate.

[Unit (a4)]

The unit (a4) is a unit (a4) based on a carboxy group-containing monomer. The unit (a4) does not include the unit (a1), the unit (a2), and the unit (a3).

Specific examples of a carboxy group-containing monomer (a4) corresponding to the unit (a4) include acrylic acid, methacrylic acid, itaconic acid, maleic acid, fumaric acid, crotonic acid, and an acid anhydride group-containing monomer (such as maleic anhydride and itaconic anhydride).

[Unit (a5)]

The unit (a5) is a unit, other than the above units (a1) to (a4), that is based on another monomer copolymerizable with the units (a1) to (a4).

Examples of other monomers (a5) corresponding to the unit (a5) include a (meth)acrylate having a linear or branched alkyl group of 13 to 20 carbon atoms, a (meth)acrylate having an aromatic ring, a (meth)acrylate having a non-aromatic cyclic hydrocarbon group, an epoxy group-containing (meth)acrylate, a vinyl ester-based monomer, a styrene-based monomer, an olefin-based monomer, a vinyl ether-based monomer, and a polyfunctional monomer.

For example, a vinyl ester-based monomer such as vinyl acetate and vinyl propionate is preferred.

### <First (Meth)Acrylic Polymer (A-1)>

The polymer (A-1) preferably contains one or more types of units (a1).

With respect to all units in the polymer (A-1), the content of the unit (a1) is preferably from 20 to 40% by mass, more preferably from 22 to 38% by mass, and still more preferably from 24 to 36% by mass. When the content of the unit (a1) is equal to or more than the lower limit value of the above range, the hydroxyl value of the polymer (A-1) is high, and the affinity with the silver particles is high, resulting in excellent stretchability. When the content of the unit (a1) is equal to or less than the upper limit value, the self-cohesive force of the meth (acrylic) polymer is not too strong, and favorable dispersibility during ink production and favorable stretchability are likely to be obtained.

The polymer (A-1) preferably contains one or more types of units (a2).

With respect to all units in the polymer (A-1), the content of the unit (a2) is preferably from 30 to 75% by mass, more preferably from 40 to 72% by mass, and still more preferably from 50 to 70% by mass. When the content of the unit (a2) is equal to or more than the lower limit value of the above range, favorable surface smoothness is likely to be obtained during printing. When the content of the unit (a2) is equal to or less than the upper limit value, it is difficult to become rigid, and favorable stretchability is likely to be obtained.

The polymer (A-1) may contain one or more types of units (a3).

The content of the unit (a3) is preferably equal to or less than 50% by mass, more preferably equal to or less than 45% by mass, still more preferably equal to or less than 40% by mass, and may be zero with respect to all units in the polymer (A-1). When the content of the unit (a3) is equal to or less than the upper limit value, the adhesion to the substrate is excellent.

On the other hand, from the viewpoints of excellent flexibility and sufficient stretchability, it is preferable that the polymer (A-1) contains one or more types of units (a3). For example, the content of the unit (a3) with respect to all units in the polymer (A-1) may be 2% by mass or more, 5% by mass or more, or 7% by mass or more.

The polymer (A-1) may contain one or more types of units (a4).

The content of the unit (a4) is preferably equal to or less than 0.35% by mass, more preferably equal to or less than 0.30% by mass, still more preferably equal to or less than 0.25% by mass, and may be zero with respect to all units in the polymer (A-1). When the content of the unit (a4) is equal to or less than the upper limit value, the cohesive force of (meth)acrylic acid is not too high, and favorable stretchability is likely to be obtained.

On the other hand, from the viewpoint of favorable affinity with silver particles, it is preferable that the polymer (A-1) contains one or more types of units (a4). For example, the content of the unit (a4) with respect to all units in the polymer (A-1) may be 0.05% by mass or more, 0.10% by mass or more, or 0.15% by mass or more.

The polymer (A-1) may contain one or more types of units (a5).

The content of the unit (a5) is preferably equal to or less than 10% by mass, more preferably equal to or less than 5% by mass, still more preferably equal to or less than 2% by mass, and may be zero with respect to all units in the polymer (A-1). When the content of the unit (a5) is equal to or less than the upper limit value, suitable printability can be ensured.

The glass transition temperature of the polymer (A-1) is equal to or less than 0° C., preferably less than −15° C., more preferably less than −30° C., and still more preferably less than −40° C. When the glass transition temperature of the polymer (A-1) is equal to or less than the above upper limit value, a favorable elongation rate can be obtained.

The lower limit of the glass transition temperature of the polymer (A-1) is preferably greater than −60° C. When the glass transition temperature of the polymer (A-1) is higher than −60° C., sufficient stretchability is likely to be obtained.

The glass transition temperature of the polymer (A-1) is, for example, preferably higher than −60° C. and lower than −15° C., more preferably higher than −60° C. and lower than −30° C., and still more preferably higher than −60° C. and lower than −40° C.

The weight average molecular weight of the polymer (A-1) is 500,000 or more, preferably 600,000 or more, more preferably 670,000 or more, and still more preferably 750,000 or more. When the above weight average molecular weight is equal to or more than the lower limit value described above, the stretchability is excellent.

The upper limit of the weight average molecular weight of the polymer (A-1) is preferably 990,000 or less from the viewpoint of ensuring flexibility and fully exhibiting electrical conductivity.

The weight average molecular weight of the polymer (A-1) is, for example, preferably 500,000 or more and 990,000 or less, more preferably 600,000 or more and 990,000 or less, still more preferably 670,000 or more and 990,000 or less, and particularly preferably 750,000 or more and 990,000 or less.

The hydroxyl value of the polymer (A-1) is preferably 50 mgKOH/g or higher, more preferably 75 mgKOH/g or higher, and still more preferably 100 mgKOH/g or higher. When the hydroxyl value of the polymer (A-1) is 50 mgKOH/g or higher, the affinity between the silver particles and the polymer (A-1) is moderately high, and the stretchability is excellent.

The upper limit of the above hydroxyl value of the polymer (A-1) is preferably 200 mgKOH/g or lower, more preferably 175 mgKOH/g or lower, and still more preferably 150 mgKOH/g or lower from the viewpoint of not inhibiting the electrical conductivity of the silver particles.

The hydroxyl value of the polymer (A-1) is, for example, preferably 50 mgKOH/g or higher and 200 mgKOH/g or lower, more preferably 75 mgKOH/g or higher and 175 mgKOH/g or lower, and still more preferably 100 mgKOH/g or higher and 150 mgKOH/g or lower.

Examples of a preferred aspect of the polymer (A-1) include the following aspects (A1-i), (A1-ii), and (A1-iii).

### Aspect (A1-i)

A (meth)acrylic polymer in which the content of the unit (a1) is from 20 to 40% by mass,
the content of the unit (a2) is from 30 to 75% by mass,
the content of the unit (a3) is from 0 to 50% by mass,
the content of the unit (a4) is from 0 to 0.35% by mass,
the content of the unit (a5) is 10% by mass or less,
the glass transition temperature is higher than −60° C. and lower than 0° C.,
the weight average molecular weight is from 500,000 to 990,000, and
the hydroxyl value is 50 mgKOH/g or higher and 200 mgKOH/g or lower. It should be noted that the total of the units (a1) to (a5) does not exceed 100% by mass.

### Aspect (A1-ii)

A (meth)acrylic polymer in which the content of the unit (a1) is from 22 to 38% by mass,
the content of the unit (a2) is from 40 to 72% by mass,
the content of the unit (a3) is from 0 to 40% by mass,
the content of the unit (a4) is from 0.10 to 0.30% by mass,
the content of the unit (a5) is 5% by mass or less,
the glass transition temperature is higher than −60° C. and lower than −30° C.,
the weight average molecular weight is from 670,000 to 990,000, and
the hydroxyl value is 75 mgKOH/g or higher and 175 mgKOH/g or lower. It should be noted that the total of the units (a1) to (a5) does not exceed 100% by mass.

### Aspect (A1-iii)

A (meth)acrylic polymer in which the content of the unit (a1) is from 24 to 36% by mass,
the content of the unit (a2) is from 50 to 70% by mass,
the content of the unit (a3) is from 0 to 30% by mass,
the content of the unit (a4) is from 0.15 to 0.25% by mass,
the content of the unit (a5) is 2% by mass or less,
the glass transition temperature is higher than −60° C. and lower than −45° C.,
the weight average molecular weight is from 750,000 to 990,000, and
the hydroxyl value is 100 mgKOH/g or higher and 150 mgKOH/g or lower. It should be noted that the total of the units (a1) to (a5) does not exceed 100% by mass.

### <Second (Meth)Acrylic Polymer (A-2)>

The polymer (A-2) may contain one or more types of units (a1).

The content of the unit (a1) is preferably equal to or less than 10% by mass, more preferably equal to or less than 5% by mass, still more preferably equal to or less than 1% by mass, and may be zero with respect to all units in the polymer (A-2). When the content of the unit (a1) is equal to or less than the upper limit value, the self-cohesive force of the meth (acrylic) polymer is not too strong, and favorable dispersibility during ink production and favorable stretchability are likely to be obtained.

On the other hand, from the viewpoint of excellent stretchability, it is preferable that the polymer (A-2) contains one or more types of units (a1). For example, the content of the unit (a1) with respect to all units in the polymer (A-2) may be 0.05% by mass or more, 0.1% by mass or more, or 0.15% by mass or more.

The polymer (A-2) preferably contains one or more types of units (a2).

With respect to all units in the polymer (A-2), the content of the unit (a2) is preferably from 70 to 98% by mass, more preferably from 73 to 95% by mass, and still more preferably from 76 to 92% by mass. When the content of the unit (a2) is equal to or more than the lower limit value of the above range, favorable surface smoothness is likely to be obtained during printing. When the content of the unit (a2) is equal to or less than the upper limit value, it is difficult to become rigid, and favorable stretchability is likely to be obtained.

The polymer (A-2) may contain one or more types of units (a3).

The content of the unit (a3) is preferably equal to or less than 2.0% by mass, more preferably equal to or less than 1.8% by mass, still more preferably equal to or less than 1.6% by mass, and may be zero with respect to all units in the polymer (A-2). When the content of the unit (a3) is equal to or less than the upper limit value, the adhesion to the substrate is excellent.

On the other hand, from the viewpoints of excellent flexibility and sufficient stretchability, it is preferable that the polymer (A-2) contains one or more types of units (a3). For example, the content of the unit (a3) with respect to all units in the polymer (A-2) may be 0.4% by mass or more, 0.6% by mass or more, or 0.8% by mass or more.

The polymer (A-2) preferably contains one or more types of units (a4).

With respect to all units in the polymer (A-2), the content of the unit (a4) is preferably from 1 to 7% by mass, more preferably from 1 to 5% by mass, and still more preferably from 1 to 3% by mass. When the content of the unit (a4) is equal to or more than the lower limit value of the above range, the affinity with the silver particles is excellent, and sufficient stretchability is likely to be obtained. When the content of the unit (a4) is equal to or less than the upper limit value, the cohesive force of (meth)acrylic acid is not too high, and favorable stretchability is likely to be obtained.

The polymer (A-2) may contain one or more types of units (a5).

The content of the unit (a5) is preferably equal to or less than 12% by mass, more preferably equal to or less than 10% by mass, still more preferably equal to or less than 8% by mass, and may be zero with respect to all units in the polymer (A-2). When the content of the unit (a5) is equal to or less than the upper limit value, the cohesive force of (meth)acrylic acid is not too high, and favorable stretchability is likely to be obtained.

On the other hand, from the viewpoint of increasing the affinity with the silver particles, it is preferable that the polymer (A-2) contains one or more types of units (a5). For example, the content of the unit (a5) with respect to all units in the polymer (A-2) may be 1% by mass or more, 3% by mass or more, or 5% by mass or more.

The glass transition temperature of the polymer (A-2) is equal to or less than 0° C., preferably less than 0° C., more preferably less than −15° C., and still more preferably less than −30° C. When the glass transition temperature of the polymer (A-2) is equal to or less than the above upper limit value, a favorable elongation rate can be obtained.

The lower limit of the glass transition temperature of the polymer (A-2) is preferably greater than −70° C., more preferably greater than −65° C., and still more preferably greater than −60° C. When the glass transition temperature of the polymer (A-2) is higher than −70° C., sufficient stretchability is likely to be obtained.

The glass transition temperature of the polymer (A-2) is, for example, preferably higher than −70° C. and lower than −0° C., more preferably higher than −65° C. and lower than −15° C., and still more preferably higher than −60° C. and lower than −30° C.

The weight average molecular weight of the polymer (A-2) is less than 500,000, preferably equal to or less than 450,000, more preferably equal to or less than 400,000, and still more preferably equal to or less than 350,000. When the above weight average molecular weight is equal to or less than the above upper limit value, the ink viscosity does not become too high and the printability is excellent.

The lower limit of the weight average molecular weight of the polymer (A-2) is preferably equal to or more than 100,000, more preferably equal to or more than 150,000, and still more preferably equal to or more than 200,000, from the viewpoint of excellent stretchability.

The weight average molecular weight of the polymer (A-2) is, for example, preferably equal to or more than 100,000 and less than 500,000, more preferably equal to or more than 150,000 and less than 450,000, and still more preferably equal to or more than 200,000 and equal to or less than 400,000.

The hydroxyl value of the polymer (A-2) is preferably 50 mgKOH/g or lower, more preferably 20 mgKOH/g or lower, and may be zero. When the hydroxyl value of the polymer (A-2) is equal to or less than the above upper limit value, the affinity between the silver particles and the polymer (A-2) is not too high, the ink viscosity becomes moderate, and the printability is excellent.

Examples of a preferred aspect of the polymer (A-2) include the following aspects (A2-i) and (A2-ii).

### Aspect (A2-i)

A (meth)acrylic polymer in which the content of the unit (a1) is 10% by mass or less,
the content of the unit (a2) is from 70 to 98% by mass,
the content of the unit (a3) is 2.0% by mass or less,
the content of the unit (a4) is from 1 to 7% by mass,
the content of the unit (a5) is 12% by mass or less,
the glass transition temperature is higher than −70° C. and lower than 0° C.,
the weight average molecular weight is 100,000 or more and less than 500,000, and
the hydroxyl value is from 0 to 50 mgKOH/g. It should be noted that the total of the units (a1) to (a5) does not exceed 100% by mass.

### Aspect (A2-ii)

A (meth)acrylic polymer in which the content of the unit (a1) is from 0.05 to 1% by mass,
the content of the unit (a2) is from 73 to 95% by mass,
the content of the unit (a3) is from 0.8 to 1.6% by mass,
the content of the unit (a4) is from 1 to 3% by mass,
the content of the unit (a5) is from 5 to 8% by mass,
the glass transition temperature is higher than −65° C. and lower than −15° C.,
the weight average molecular weight is 200,000 or more and less than 400,000, and
the hydroxyl value is from 0 to 20 mgKOH/g. It should be noted that the total of the units (a1) to (a5) does not exceed 100% by mass.

### < (Meth)Acrylic Polymer Composition>

The (meth)acrylic polymer (A) may be produced by a known method for producing a (meth)acrylic polymer, or a commercially available product may be used.

Each of the polymers (A-1) and (A-2) may be used in the form of a (meth)acrylic polymer composition containing a (meth)acrylic polymer and an arbitrary solvent for preparing a conductive ink composition. The solid content of the (meth)acrylic polymer composition is not particularly limited, but from the viewpoint of handling during blending, it is desirable to have a viscosity that imparts appropriate fluidity. The solid content of the (meth)acrylic polymer composition is, for example, preferably 50% by mass or less and 10% by mass or more, and more preferably 40% by mass or less and 20% by mass or more.

The solvent contained in the (meth)acrylic polymer composition may be any solvent that is compatible with the polymer (A-1) and the polymer (A-2). For example, it may be a solvent (such as ethyl acetate) known as a polymerization solvent when synthesizing a (meth)acrylic polymer. It may also be a solvent listed as an example of a solvent (C) described later.

### <Silver Particles (B)>

The surface of the silver particles (B) is coated with a fatty acid containing oleic acid.

The 50% average particle size of the silver particles (B) is preferably from 0.5 to 14.0 μm, and more preferably from 1.0 to 12.0 μm. The shape of the silver particles (B) is not particularly limited. For example, they may have a spherical shape or a shape that is flat in one direction (such as a flake-like shape or a scale-like shape).

Examples of preferred silver particles (B) include spherical silver particles with a 50% average particle size of 0.5 μm or more and less than 5 μm, and flake-like silver particles with a 50% average particle size of 5 μm or more and 15 μm or less.

The fatty acid coating the surface of the silver particles (B) may contain a fatty acid other than oleic acid. The content of oleic acid is preferably 85% by mass or more, more preferably 90% by mass or more, and may be 100% by mass, with respect to the total mass of the above fatty acid.

In the present description, the content of fatty acid with respect to the total mass of silver particles (B) is defined as the fatty acid coating amount. The fatty acid coating amount of silver particles (B) is preferably from 0.01 to 2.0% by mass, more preferably from 0.05 to 1.5% by mass, and still more preferably from 0.1 to 1.0% by mass.

### <Solvent (C)>

The conductive ink composition may contain a solvent (C) as necessary.

The solvent (C) is not particularly limited as long as it can uniformly disperse the (meth)acrylic polymer (A) and the silver particles (B), has low volatility and maintains the ink properties stable, and can be removed in a drying step during conductive film formation.

Examples of the solvent (C) include ester-based solvents such as diethylene glycol monoethyl ether acetate (also known as ethyl carbitol acetate), hydrocarbon-based solvents such as decane, tetradecane, and cyclohexane, and alcohol-based solvents such as 2-ethylhexanol, 2-ethylhexyl ether derivatives, and diethylene glycol monobutyl ether.

### <Optional Components>

The conductive ink composition may contain an optional component other than the (meth)acrylic polymer (A), the silver particles (B), and the solvent (C) within a range that does not impair the effects of the present invention.

As the optional component, a component known in the field of conductive ink composition can be used.

For example, in order to improve printability, a component that adjusts the interfacial tension of the ink (for example, a surfactant, a leveling agent, and the like), a component that adjusts the viscosity of the ink (for example, a thixotropic agent), and the like may be blended.

Further, for the purpose of improving adhesion to each substrate, it is possible to blend a binder component different from the (meth)acrylic polymer (A). Examples of the binder component include polyurethane polymers, epoxy polymers, ester polymers, terpene resins, and terpene resin derivatives (for example, terpene phenolic resins and the like). The binder component can be blended in an amount that does not impair stretchability.

In addition, an ion scavenger can be blended for the purpose of preventing migration.

### Content

The content of the (meth)acrylic polymer (A) with respect to the solid content of the conductive ink composition is preferably from 5 to 20% by mass, more preferably from 6 to 18% by mass, and still more preferably from 7 to 16% by mass. When the content of the (meth)acrylic polymer (A) is equal to or more than the above lower limit value, sufficient stretchability is likely to be obtained. When the content of the (meth)acrylic polymer (A) is equal to or less than the above upper limit value, it is easy to ensure a sufficient content of the silver particles (B), and favorable electrical conductivity during expansion and contraction can be easily obtained.

Each of the polymer (A-1) and the polymer (A-2) contained in the conductive ink composition may be one type, or two or more types thereof may be used in combination.

The total content of the polymer (A-1) and the polymer (A-2) with respect to the total mass of the (meth)acrylic polymer (A) is preferably 90% by mass or more, more preferably 95% by mass or more, and may be 100% by mass.

In the conductive ink composition, (A-1): (A-2) representing a mass ratio of the content of the polymer (A-1) to the content of the polymer (A-2) is preferably from 65:35 to 95:5, more preferably from 70:30 to 90:10, and still more preferably from 75:25 to 85:15. When the mass ratio of (A-1): (A-2) is equal to or more than the above lower limit value, sufficient stretchability is likely to be obtained. When the mass ratio of (A-1): (A-2) is equal to or less than the above upper limit value, it is easy to obtain a viscosity suitable for printing.

The silver particles (B) contained in the conductive ink composition may be of one type, or two or more types thereof may be used in combination.

The content of the silver particles (B) with respect to the solid content of the conductive ink composition is preferably from 80.0 to 97.0% by mass, more preferably from 83.0 to 95.0% by mass, and still more preferably from 86.0 to 93.0% by mass. When the content of the silver particles (B) is equal to or more than the above lower limit value, favorable electrical conductivity is likely to be obtained. When the content of the silver particles (B) is equal to or less than the above upper limit value, it is easy to ensure a sufficient content of components other than the silver particles (B), and favorable properties such as stretchability are likely to be obtained.

The optional component contained in the conductive ink composition may be of one type, or two or more types thereof may be used in combination. The content of the optional component with respect to the solid content of the conductive ink composition is preferably 10% by mass or less, more preferably 5% by mass or less, and may be zero.

The solid content with respect to the total mass of the conductive ink composition is preferably from 55 to 87% by mass, more preferably from 57 to 84% by mass, and still more preferably from 60 to 82% by mass. When the solid content is equal to or more than the above lower limit value, sufficient extensibility and favorable electrical conductivity during elongation are likely to be obtained. When the solid content is equal to or less than the above upper limit value, it is easy to obtain a viscosity suitable for printing.

The solid content of the conductive ink composition can be adjusted through the content of the solvent (C). The solvent (C) contained in the conductive ink composition may be of one type, or two or more types thereof may be used in combination.

### <Method for Producing Conductive Ink Composition>

The conductive ink composition is obtained by uniformly mixing the polymer (A-1), the polymer (A-2), the silver particles (B), and if required, the solvent (C) and the optional component.

The polymer (A-1) and the polymer (A-2) may be mixed in advance for use. As the polymer (A-1), the polymer (A-2), or a mixture thereof, a (meth)acrylic polymer composition containing a solvent compatible with both the polymer (A-1) and the polymer (A-2), and the polymer (A-1), the polymer (A-2), or a mixture thereof may be used.

A known method can be used as the mixing method. For example, the conductive ink composition can be produced by a method in which all the components are premixed using a stirrer, and the obtained premix is kneaded a plurality of times using a triple roll mill.

The glass transition temperatures of the polymer (A-1) and the polymer (A-2) contained in the conductive ink composition may be the same as or different from each other. Among the glass transition temperatures of the polymer (A-1) and the polymer (A-2) contained in the conductive ink composition, the absolute value of the difference between the highest glass transition temperature and the lowest glass transition temperature is preferably 60° C. or less, and more preferably 30° C. or less.

Among the polymer (A-1) and the polymer (A-2) contained in the conductive ink composition, the polymer (A-1) has a higher weight average molecular weight. Among the weight average molecular weights of the polymer (A-1) and the polymer (A-2) contained in the conductive ink composition, the absolute value of the difference between the highest weight average molecular weight and the lowest weight average molecular weight is preferably from 200,000 to 890,000, and more preferably from 300,000 to 500,000. For example, it is preferable that the weight average molecular weight of the polymer (A-1) is 600,000 or more and the weight average molecular weight of the polymer (A-2) is 400,000 or less. It is more preferable that the weight average molecular weight of the polymer (A-1) is 800,000 or more and the weight average molecular weight of the polymer (A-2) is 300,000 or less.

Among the polymer (A-1) and the polymer (A-2) contained in the conductive ink composition, the polymer (A-1) preferably has a higher hydroxyl value. Among the hydroxyl values of the polymer (A-1) and the polymer (A-2) contained in the conductive ink composition, the absolute value of the difference between the highest hydroxyl value and the lowest hydroxyl value is preferably from 0 to 200 mgKOH/g, and more preferably from 50 to 150 mgKOH/g.

For example, it is preferable that the hydroxyl value of the polymer (A-1) is 100 mgKOH/g or more and the hydroxyl value of the polymer (A-2) is 50 mgKOH/g or less. It is more preferable that the hydroxyl value of the polymer (A-1) is 120 mgKOH/g or more and the hydroxyl value of the polymer (A-2) is 25 mgKOH/g or less.

### <Physical Properties>

The conductive ink composition preferably has a loss factor tan δ of 4.0 or less, which is measured by changing an amount of strain from 0.001% to 100% at a temperature of 25° C. and a frequency of 1 Hz. When the above tan δ is 4.0 or less, the printability is excellent, for example, both the fine line printability and the surface smoothness after printing are excellent.

From the viewpoint of excellent surface smoothness, the above tan δ is preferably 4.0 or less, and more preferably 3.0 or less. From the viewpoint of excellent fine line printability, the lower limit of the above tan δ is preferably 0.5 or more, and more preferably 1.0 or more.

The value of the above tan δ can be adjusted mainly by the glass transition temperature and weight average molecular weight of each of the polymers (A-1) and (A-2), the combination of the polymers (A-1) and (A-2), the mass ratio of the polymers (A-1) and (A-2), or the type of fatty acid coating the surface of the silver particles (B). When the fatty acid coating the silver particles (B) is oleic acid, the value of the above tan δ tends to be small.

### <Conductive Film>

A conductive film is obtained by applying the conductive ink composition onto a substrate or the like to form a coating film, and drying the coating film to remove a volatile component such as the solvent (C).

The material and shape of the substrate are not particularly limited. A stretchable substrate is preferred. Examples of the stretchable material include polyurethane, ethylene propylene rubber, silicone rubber, and various elastomers.

A known coating method can be used as a method for applying the conductive ink composition onto the substrate. Examples thereof include a printing method, a dipping method, a spray method, and a bar coating method. A printing method is preferred from the viewpoint of versatility and accuracy.

Examples of the printing method include an inkjet printing method, a flexographic printing method, a gravure printing method, a screen printing method, a pad printing method, and a lithography printing method. In particular, a screen printing method is preferred because it is easy to reduce costs, is suitable for large-area printing, and is easy to increase the thickness of the conductive film.

The coating film may be heated in a drying step. The heating temperature during drying is preferably a temperature that does not adversely affect the substrate and allows complete removal of the solvent in the coating material. Although it varies depending on the type of the substrate, for example, the temperature is preferably from 80 to 150° C.

The thickness of the conductive film after drying is not particularly limited, but is preferably, for example, from 10 to 100 μm, and more preferably from 20 to 80 μm. When the thickness is equal to or more than the lower limit value of the above range, the electrical conductivity can be easily exhibited, and when the thickness is equal to or less than the upper limit value, the device to be produced can be made smaller in size.

The conductive film of the present embodiment is stretchable as shown in Examples described later, and exhibits favorable electrical conductivity after stretching. For example, a surface resistivity of less than 0.7 Ω/sq, preferably less than 0.6 Ω/sq, and more preferably less than 0.5 (2/sq can be achieved after stretching at an elongation rate of 50%. In other words, the conductive ink composition of the present embodiment can be suitably used as a conductive material for forming wiring, electrodes, and the like on a stretchable substrate, and favorable followability with respect to the stretching of the substrate can be obtained.

In addition, the conductive ink composition of the present embodiment exhibits excellent printability, as shown in Examples described later. More specifically, when a line and space (L/S) pattern is printed using the conductive ink composition, the difference between the line width of the printed pattern and the design value is small, resulting in excellent fine line printability. Further, the surface roughness of the coating film after printing is small, and the surface smoothness of the coating film is excellent.

Therefore, the conductive ink composition of the present embodiment is suitable for applications in which conductive members such as wiring and electrodes are formed on a stretchable substrate by a printing method.

Since the conductive film of the present embodiment can exhibit high electrical conductivity even when stretched, it can also be used for conductive members (such as wiring, electrodes, antennas, and heating elements) that constitute stretchable articles. Specific examples thereof include use for conductive members (such as wiring, electrodes, and antennas) that constitute the above wearable sensor, the above pressure-sensitive sensor, a moving part of a robot, an artificial muscle, a flexible display or the like, wiring of an in-mold molded part, heating elements of a flexible heater, and the like.

For example, the conductive film of the present embodiment is suitable for use in an electrode that requires stretchability in an electronic device, or for use in wiring that requires stretchability in an electronic device.

For example, the conductive film of the present embodiment is suitable for use in a detection part of a variable resistance sensor, an electrode of a variable resistance sensor, or wiring of a variable resistance sensor.

Specific examples of the variable resistance sensor include a wearable sensor or flexible sensor that detects expansion and contraction by changes in electrical resistance, a strain sensor that measures the amount of strain by changes in electrical resistance, and a pressure-sensitive sensor capable of perceiving deformation and measuring the amount of deformation by changes in electrical resistance.

### EXAMPLES

Hereinafter, the present invention will be described in more detail with reference to Examples, but the present invention is not limited by the following description. In the following description, the unit “%” of the content is “% by mass” unless otherwise specified.

### Production Example of (Meth)Acrylic Polymer Composition

The monomers shown in Table 1 are as follows.

[Hydroxyl Group-Containing Monomer (a1)]
2HPA: 2-hydroxypropyl acrylate.
4HBA: 4-hydroxybutyl acrylate.
2HEA: 2-hydroxyethyl acrylate.
2HEMA: 2-hydroxyethyl methacrylate.
   [C4-12 alkyl (meth)acrylate (a2)]
BA: butyl acrylate.
2EHA: 2-ethylhexyl acrylate.
   [C1-3 alkyl (meth)acrylate (a3)]
MA: methyl acrylate.
MMA: methyl methacrylate.
   [Carboxy Group-Containing Monomer (a4)]
AA: acrylic acid.
   [Other Monomer (a5)]
Vac: vinyl acetate.

### Production Example 1-1: Production of (Meth)Acrylic Polymer Composition

A (meth)acrylic polymer was synthesized by polymerizing a monomer mixture shown in Table 1 in a polymerization solvent, and a solvent was further added thereto to adjust the solid content concentration to obtain a (meth)acrylic polymer composition.

More specifically, 29.8 parts by mass of 2HPA, 57.2 parts by mass of BA, 12.8 parts by mass of MA, and 0.2 parts by mass of AA as monomers, and 0.02 parts by mass of 2,2′-azobisisobutyronitrile as a polymerization initiator and 43 parts by mass of ethyl acetate as a polymerization solvent were placed in a separable flask. After nitrogen gas was introduced to remove oxygen in the polymerization system, the temperature was raised to 70° C., and the reaction was carried out for 8 hours to obtain a (meth)acrylic polymer A-1-1. Ethyl acetate was added thereto to adjust the solid content concentration to 33% by mass to obtain a (meth)acrylic polymer composition (1-1). The glass transition temperature, weight average molecular weight, and hydroxyl value of the (meth)acrylic polymer are shown in Table 1 (the same applies hereinafter).

### Production Examples 1-2, 1-3, 2-1, 2-2, 3-1: Production of (Meth)Acrylic Polymer Compositions

The compositions of monomer mixtures were changed as shown in Table 1, and the monomer mixtures were polymerized in the same manner as in Production Example 1-1 to synthesize (meth)acrylic polymers. Ethyl acetate was added thereto to adjust the solid content concentrations as shown in Table 1 to obtain (meth)acrylic polymer compositions.

Production Examples 1-2 and 1-3 are examples in which a first (meth)acrylic polymer (A-1) was produced, and Production Examples 2-1 and 2-2 are examples in which a second (meth)acrylic polymer (A-2) was produced.

Production Example 3-1 is an example in which a (meth)acrylic polymer (A-3-1) with a glass transition temperature exceeding 0° C. was produced.

TABLE 1

| | | | Production | Production | Production | Production | Production | Production |
|---|---|---|---|---|---|---|---|---|
| | | | Example | Example | Example | Example | Example | Example |
| | | | 1-1 | 1-2 | 1-3 | 2-1 | 2-2 | 3-1 |
| Monomer mixture | (a1) | 2HPA | 29.8 | 29.9 | 29.9 | — | — | 29.9 |
| (parts by mass) | | 4HBA | — | — | — | — | 0.1 | — |
| | | 2HEA | — | — | — | — | — | — |
| | | 2HEMA | — | — | — | — | — | — |
| | (a2) | BA | 57.2 | 32.5 | — | — | 35.5 | — |
| | | DEHA | — | — | 69.9 | 95.8 | 54.9 | |
| | (a3) | MA | 12.8 | 37.6 | — | — | — | 70.1 |
| | | MMA | — | — | — | — | 0.9 | — |
| | (a4) | AA | 0.2 | — | 0.2 | 4.2 | 2.0 | — |
| | (a5) | Vac | — | — | — | — | 6.6 | — |

| | | | | | | | |
|---|---|---|---|---|---|---|---|
| | Total | 100 | 100 | 100 | 100 | 100 | 100 |
| (Meth)acrylic | Glass transition temperature (° C.) | −36 | −20 | −55 | −65 | −57 | 3.3 |
| polymer (A) | Weight average molecular weight | 700,000 | 650,000 | 800,000 | 150,000 | 300,000 | 510,000 |
| | Hydroxyl value (mgKOH/g) | 130 | 130 | 130 | 0 | 1 | 129 |
| | Name | A-1-1 | A-1-2 | A-1-3 | A-2-1 | A-2-2 | A-3-1 |

| (Meth)acrylic polymer composition | Name | (1-1) | (1-2) | (1-3) | (2-1) | (2-2) | (3-1) |
|---|---|---|---|---|---|---|---|
| | Solid content (%) | 33 | 29 | 34 | 45 | 50 | 34 |

### <Silver Particles (B)>

Silver particles B1 to B3 coated with fatty acids were used. Table 2 shows the shape, 50% average particle size, main fatty acid component, content of main component with respect to the total mass of fatty acid (referred to as “main component/fatty acid” in the table), and fatty acid coating amount of each silver particle.

TABLE 2

| | | | 50% | | | |
|---|---|---|---|---|---|---|
| | | | average | Main fatty | Main | Fatty acid |
| | | Particle | particle size | acid | component/ | coating |
| | | shape | (μm) | component | fatty acid (%) | amount (%) |
| Silver | B1 | Spherical | 1.5 to 3.5 | Oleic acid | 85 | 0.1 to 1.0 |
| particles | B2 | Flake-like | 6.0 to 12.0 | Oleic acid | 95.6 | 0.5 |
| (B) | B3 | Flake-like | 6.0 to 12.0 | Stearic acid | 92 | 0.5 |

### <Solvent (C)>

The following solvent was used.

Solvent (C1): diethylene glycol monoethyl ether acetate.

### Examples 1 to 8, Comparative Examples 1 to 5

The silver particles and the solvent were blended into a (meth)acrylic polymer composition according to the proportions shown in Tables 3 and 4. All the ingredients were premixed using a stirrer and then kneaded using a triple roll mill (“BR-150VIII” (product name), manufactured by Imex Co., Ltd.) to obtain a conductive ink composition. The kneading was performed under conditions in which a treatment was carried out twice at a rotational frequency of 350 rpm and a distance between the rolls of 40 μm, and then a treatment was further carried out twice after reducing the distance between the rolls to 10 μm.

The solid content, the content of the (meth)acrylic polymer (A), and the content of the silver particles (B) with respect to the total mass of the conductive ink composition of each example are shown in the table. Further, the content of the (meth)acrylic polymer (A) and the content of the silver particles (B) with respect to the solid content are shown in the table (described as (meth)acrylic polymer (A)/solid content and silver particle (B)/solid content in the table, respectively).

It should be noted that a blank column in the table means that the ingredient is not blended.

### Evaluation Method

### <Ink Evaluation>

### [Loss Factor of Conductive Ink Composition]

The dynamic viscoelasticity of the ink was evaluated using a rheometer (“MCR301” (product name) manufactured by Anton Paar GmbH). The storage modulus (G′) and loss modulus (G″) were measured at a frequency of 1 Hz and a measurement temperature of 25° C. while changing the amount of strain from 0.001% to 100%, and the loss factor (Tan δ) was determined using the following formula.

$$tan δ = loss modulus {G}^{″} / storage modulus {G}^{′}$$

The results of the storage modulus (G′), loss modulus (G″), and loss factor (G″/G′) at 100% strain are shown in the table.

### Evaluation Method

### <Printability Evaluation>

### (Method for Evaluating Fine Line Printability)

The ink composition obtained in each example was screen printed on a substrate using a screen printer (“MT-320” (product name) manufactured by Micro-tec Co., Ltd.), and then subjected to a drying treatment to form a conductive film (fine wiring pattern) with a thickness of 12 μm (design value). More specifically, it was printed on a 15 mm long and 15 mm wide area of a 1 mm thick substrate using a screen plate with a fine wiring pattern, followed by a drying treatment at 130° C. for 20 minutes. The fine wiring pattern had a line width of 500 μm and a space between the lines of 300 μm (L/S=500μ m/300μ m).

The printing conditions are as follows. The substrate used was elastic polyurethane, but is not limited thereto, and rubber or elastomer materials such as EPDM rubber (ethylene propylene rubber) and silicone rubber can also be used.

### (Screen Printing Conditions)

Screen: stainless steel plate 325 mesh.
Line diameter: 30 μm
Calendered mesh thickness: 75 μm
Emulsion thickness: 20 μm
Screen frame: 320×320 mm
Squeegee angle: 70°-Squeegee hardness: 80°-Squeegee speed: 150 mm/sec.
Squeegee pressure: 0.2 MPa
Clearance: 1.5 mm

The conductive film (fine wiring pattern) obtained by the drying treatment was evaluated for fine line printability using the following method.

The screen-printed fine wiring pattern was photographed at a magnification of ×500 using a digital microscope (“VHX-6000” (product name), manufactured by Keyence Corporation), the line widths of five arbitrarily selected wirings (designed line width: 500 μm) in the obtained image were measured, and the average value of the five wirings was calculated. Based on the obtained average line width, the fine line printability was evaluated according to the following evaluation criteria.

### Evaluation Criteria

A: The average line width is 480 μm or more and less than 520 μm.
B: The average line width is 475 μm or more and less than 480 μm, or 520 μm or more and less than 535 μm.
C: The average line width is less than 475 μm, or 535 μm or more.

### (Method for Evaluating Surface Smoothness)

The ink composition obtained in each example was applied onto a substrate and then subjected to a drying treatment to form a conductive film, and the average roughness (arithmetic average roughness Ra) of the conductive film surface was measured. The arithmetic average roughness Ra was measured using a method conforming to JIS B0601:1994.

Polyurethane was used as a substrate material, and screen printing was employed as a coating method. The conditions for the drying treatment were 130° C. and 20 minutes, and the average thickness of the conductive film after the drying treatment was 12 μm. The surface roughness of the conductive film was measured using a surface profile measuring device (a laser scanning microscope “VK-9700” (product name), manufactured by Keyence Corporation).

Based on the results of the average roughness measurements, the surface smoothness was evaluated according to the following evaluation criteria.

### Evaluation Criteria

A: The average roughness is less than 0.2 μm.
B: The average roughness is 0.2 μm or more and less than 0.4 μm.
C: The average roughness is 0.4 μm or more.

### <Evaluation of Conductive Film Stretchability>

(Measurement of Surface Resistivity after Stretching)

The ink composition obtained in each example was applied onto a substrate cut into a No. 3 dumbbell shape and subjected to a drying treatment to form a conductive film, thereby obtaining a laminate of the substrate and the conductive film.

The obtained laminate was set in a tensile testing machine as a sample. The distance between the marked lines (initial dimension) was set to 2 mm. The sample was pulled to an elongation rate of 50% at a tensile speed of 10 mm/min under conditions of 23° C., and after reaching 50% elongation, the sample was returned to its initial state at a return speed of 10 mm/min. Three minutes after returning to the initial state, the surface resistivity (unit: (2/sq) between the marked lines was measured using a tester.

Based on the results of the surface resistivity measurements, the stretchability of the conductive film was evaluated according to the following evaluation criteria.

### Evaluation Criteria

A: Less than 0.5 Ω/sq.
B: 0.5 Ω/sq or more, and less than 0.7 Ω/sq.
C: 0.7 Ω/sq or more.

TABLE 3

| | | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|---|
| Proportion of conductive ink | | (Meth)acrylic polymer | (1-1) | 17 | 17 | | | | | | |
| composition (% by mass) | | composition | (1-2) | | | 17 | | | | | |
| | | | (1-3) | | | | 17 | 20 | 17 | 17 | 12 |
| | | | (2-1) | | | | | | 3 | | |
| | | | (2-2) | 3 | 3 | 3 | 3 | | | 3 | 3 |
| | | | (3-1) | | | | | | | | |
| | | Silver particles (B) | B1 | 60 | | 60 | 60 | 60 | 60 | 30 | 60 |
| | | | B2 | | 60 | | | | | 30 | |
| | | | B3 | | | | | | | | |
| | | Solvent (C) | C1 | 20 | 20 | 20 | 20 | 17 | 20 | 20 | 25 |
| | | Total | | 100 | 100 | 100 | 100 | 100 | 100 | 100 | 100 |
| Solid content (%) | | | | 77.0 | 77.0 | 76.9 | 77.1 | 80.1 | 77.0 | 77.1 | 72.4 |
| Content of (meth)acrylic polymer (A) (%) | | | | 3.2 | 8.2 | 7.4 | 8.3 | 9.7 | 8.2 | 8.3 | 6.2 |
| Content of silver particles (B) (%) | | | | 68.9 | 68.9 | 69.4 | 68.7 | 70.3 | 68.9 | 68.7 | 66.2 |
| (Meth)acrylic polymer (A)/solid content (%) | | | | 10.6 | 10.6 | 9.7 | 10.8 | 12.2 | 10.6 | 10.8 | 8.5 |
| (A-1):(A-2) mass ratio | | | | 79:21 | 79:21 | 77:23 | 79:21 | 82:18 | 81:19 | 79:21 | 73:27 |
| Silver particles (B)/solid content (%) | | | | 89.4 | 89.4 | 90.3 | 89.2 | 87.8 | 89.4 | 89.2 | 91.5 |
| Conductive ink composition | | Storage modulus | G′ (Pa) | 39.6 | 41.2 | 43.1 | 58.9 | 62.1 | 38.3 | 42.8 | 22.6 |
| | | Loss modulus | G′ (Pa) | 124 | 136 | 110 | 148 | 171.2 | 108 | 140 | 86.4 |
| | | Loss factor | tanδ | 3.1 | 3.3 | 2.6 | 2.5 | 2.8 | 2.8 | 3.3 | 3.8 |
| Printability | Surface smoothness of | Average roughness | μm | 0.25 | 0.32 | 0.15 | 0.15 | 0.18 | 0.19 | 0.3 | 0.38 |
| | conductive film | Evaluation | | B | B | A | A | A | A | B | B |
| | Fine fine printability | Average line width | μm | 523 | 530 | 527 | 515 | 488 | 532 | 527 | 535 |

| | Evaluation | | B | B | B | A | A | B | B | B |
|---|---|---|---|---|---|---|---|---|---|---|
| Stretchability of conductive film | Surface resistivity | Ω/□ | 0.48 | 0.45 | 0.56 | 0.4 | 0.51 | 0.59 | 0.47 | 0.68 |

| | | | | | | | | |
|---|---|---|---|---|---|---|---|---|
| Evaluation | A | A | B | A | B | B | A | B |

TABLE 4

| | | | | Comp. Ex. 1 | Comp. Ex 2 | Comp. Ex. 3 | Comp. Ex. 4 | Comp. Ex. 5 |
|---|---|---|---|---|---|---|---|---|
| Proportion of conductive ink | | (Meth)acrylic polymer | (1-1) | | | | | |
| composition (% by mass) | | composition | (1-2) | | | | | 3 |
| | | | (1-3) | 14 | 17 | | | 17 |
| | | | (2-1) | | | | | |
| | | | (2-2) | | 3 | | 20 | |
| | | | (3-1) | 3 | | | | |
| | | Silver particles (B) | B1 | 60 | | 60 | 60 | 60 |
| | | | B2 | | | | | |
| | | | B3 | | 60 | | | |
| | | Solvent (C) | C1 | 23 | 20 | 20 | 20 | 20 |
| | | Total | | 100 | 100 | 100 | 100 | 100 |
| Solid content (%) | | | | 74.1 | 77.1 | 76.9 | 77.8 | 76.9 |
| Content of (meth)acrylic polymer (A) (%) | | | | 5.4 | 8.3 | 7.6 | 11.1 | 7.7 |
| Content of silver particles (B) (%) | | | | 67.6 | 68.7 | 69.3 | 66.7 | 69.2 |
| (Meth)acrylic polymer (A)/solid content (%) | | | | 7.2 | 10.8 | 9.9 | 14.3 | 10.0 |
| (A-1):(A-2) mass ratio | | | | 100:0 | 79:21 | 100:0 | 0:100 | 100:0 |
| Silver particles (B)/solid content (%) | | | | 91.2 | 89.2 | 90.1 | 85.7 | 90.0 |
| Conductive ink composition | | Storage modulus | G′ (Pa) | 44.6 | 19.8 | 34.9 | 14.2 | 36.4 |
| | | Loss modulus | G′ (Pa) | 214 | 111 | 178 | 78 | 182 |
| | | Loss factor | tanδ | 4.8 | 5.6 | 5.3 | 5.5 | 5 |
| Printability | Surface smoothness of | Average roughness | μm | 0.45 | 0.71 | 0.52 | 0.6 | 0.51 |
| | conductive film | Evaluation | | C | C | C | C | C |
| | Fine line printability | Average line width | μm | 462 | 470 | 448 | 560 | 441 |

| | Evaluation | | C | C | C | C | C |
|---|---|---|---|---|---|---|---|
| Stretchability of conductive film | Surface resistivity | Ω/□ | 0.63 | 0.66 | 0.57 | 0.82 | 0.52 |

| | | | | | |
|---|---|---|---|---|---|
| Evaluation | B | B | B | C | B |

As shown in Tables 3 and 4, the conductive ink compositions of Examples 1 to 8 were excellent in printability (surface smoothness, fine line printability) and were able to form stretchable conductive films. The conductive ink compositions of Examples 1 to 8 had a tan δ of 4.0 or less.

On the other hand, in Comparative Example 1 in which the second (meth)acrylic polymer (A-2) was not contained and the (meth)acrylic polymer (A-3-1) with a Tg exceeding 0° C. was used instead, tan δ exceeded 4.0 and the printability was poor. In Comparative Example 2 in which the fatty acid coating the surface of the silver particles did not contain oleic acid, tan δ exceeded 4.0 and the printability was poor.

In Comparative Example 3 in which the second (meth)acrylic polymer (A-2) was not contained, tan δ exceeded 4.0 and the printability was poor.

In Comparative Example 4 in which the first (meth)acrylic polymer (A-1) was not contained, tan δ exceeded 4.0 and the printability was poor. In addition, the stretchability of the conductive film was poor.

In Comparative Example 5 in which two types of first (meth)acrylic polymers (A-1) were contained and the second (meth)acrylic polymer (A-2) was not contained, tan δ exceeded 4.0 and the printability was poor.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A conductive ink composition comprising a (meth)acrylic polymer (A) and silver particles (B),
wherein said (meth)acrylic polymer (A) comprises a first (meth)acrylic polymer (A-1) and a second (meth)acrylic polymer (A-2),
said first (meth)acrylic polymer (A-1) has a glass transition temperature of 0° C. or lower and a weight average molecular weight of 500,000 or more,
said second (meth)acrylic polymer (A-2) has a glass transition temperature of 0° C. or lower and a weight average molecular weight of less than 500,000, and surfaces of said silver particles (B) are coated with a fatty acid containing oleic acid.

2. The conductive ink composition according to claim 1,
wherein said first (meth)acrylic polymer (A-1) has a glass transition temperature of more than −60° C. and less than −30° C., a weight average molecular weight of 500,000 or more and 990,000 or less, and a hydroxyl value of 50 mgKOH/g or more.

3. The conductive ink composition according to claim 1,
wherein said first (meth)acrylic polymer (A-1) has a glass transition temperature of more than −60° C. and less than −40° C., a weight average molecular weight of 750,000 or more and 990,000 or less, and a hydroxyl value of 50 mgKOH/g or more.

4. The conductive ink composition according to claim 1,
wherein said second (meth)acrylic polymer (A-2) has a glass transition temperature of more than −65° C. and less than 0° C., and a weight average molecular weight of 150,000 or more and less than 500,000.

5. The conductive ink composition according to claim 1, wherein a content of said oleic acid with respect to a total mass of said fatty acid is 85% by mass or more.

6. The conductive ink composition according to claim 1,
wherein a loss factor tan δ measured by changing an amount of strain from 0.001% to 100% at a temperature of 25° C. and a frequency of 1 Hz is 4.0 or less.

7. A conductive film obtained by drying a coating film of the conductive ink composition according to claim 1.

8. The conductive film according to claim 7, which is used for an electrode or wiring that requires stretchability in an electronic device.

9. The conductive film according to claim 7, which is used for a detection part, electrode, or wiring of a variable resistance sensor.
